(19) United States
(12) Patent Application Publication
(10) Pub. No.: US 2008/0100194 A1
(43) Pub. Date: May 1, 2008

(54) Excitation display apparatus having reset operation performed therein

(76) Inventors: Seung-Hyun Son, Suwon-si (KR); Hyoung-Bin Park, Suwon-si (KR); Mun-Ho Nam, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/789,533

(22) Filed: Apr. 25, 2007

(30) Foreign Application Priority Data
Nov. 1, 2006 (KR) 10-2006-0107461

(51) Int. Cl. H01J 1/62; G09G 1/00

(52) U.S. Cl. 313/485

(57) ABSTRACT

Provided is a gas excitation display apparatus having a gas excitation display panel and a driver. The gas excitation display panel includes: electron emitters, data electrode lines, scan electrode lines crossing the data electrode lines, phosphor cells, an excitation gas filled in a space between the phosphor cells and the electron emitters, and an anode plate to which an electric potential is applied so that electrons emitted from the electron emitters move towards the phosphor cells, wherein each horizontal driving period comprises a horizontal display time and a blanking time, and the electric potential of the anode plate in the horizontal display time is positive and the electric potential of the anode plate in the blanking time is negative.

### CROSS-REFERENCE TO RELATED PATENT APPLICATION

This application claims the benefit of Korean Patent Application No. 10-2006-0107461, filed on Nov. 1, 2006, in the Korean Intellectual Property Office, the disclosure of which is incorporated herein in its entirety by reference.

### BACKGROUND OF THE INVENTION

1. Field of the Invention

The present embodiments relate to a gas excitation display apparatus having a reset operation performed therein, and more particularly, a gas excitation display apparatus that includes a gas excitation display panel and a driver for driving the gas excitation display panel.

2. Description of the Related Art

In a typical discharge display apparatus, for example, the plasma display apparatus disclosed in U.S. Pat. No. 6,903,709, a gas is ionized by a gas discharge, and the ionized gas enters an excited state. When the excited gas stabilizes, ultraviolet rays are generated. The ultraviolet rays excite phosphor materials coated in discharge cells to emit visible light.

In a discharge display apparatus as described above, discharge for ionizing a gas is essential. However, the discharge requires a large driving power.

### SUMMARY OF THE INVENTION

The present embodiments provide a display apparatus that can function as a discharge display apparatus without generating discharge by using a low driving power.

According to an aspect of the present embodiments, there is provided a gas excitation display apparatus having a gas excitation display panel and a driver.

The gas excitation display panel may comprise: electron emitters, data electrode lines, scan electrode lines crossing the data electrode lines, phosphor cells, an excitation gas filled in a space between the phosphor cells and the electron emitters, and an anode plate to which an electric potential is applied so that electrons emitted from the electron emitters can move towards the phosphor cells.

Each horizontal driving period may comprise a horizontal display time and a blanking time. The electric potential applied to the anode plate in the horizontal display time is positive and an electric potential applied to the anode plate in the blanking time is negative.

In the horizontal display time, electrons may be emitted from the electron emitters due to the electric potential of negative polarity being applied to the cathode electrode lines, the gas may be excited by the electrons emitted from the electron emitters, the ultraviolet rays may be generated while the excited gas stabilizes, and the generated ultraviolet rays may excite the phosphor cells and the phosphor cells may emit visible light.

That is, without generating gas discharge, the gas may be excited by the emitted electrons. Accordingly, a discharge display apparatus may display an image with a low driving power.

Since the polarity of the electric potential of the anode plate is alternating, electrons accumulated in the phosphor cells in the horizontal display time may return to the electron emitters in the blanking time. As a result of the reset effect, performance and efficiency of overall operation of a gas excitation display apparatus may be increased.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view illustrating a structure of a section of a gas excitation display panel according to an embodiment;

FIG. 2 is a block diagram showing the configuration of a driver of the gas excitation display panel of FIG. 1, according to an embodiment;

FIG. 3 is a timing diagram showing an example of a driving signal generated by the driver of FIG. 2, according to an embodiment; and

FIG. 4 is a timing diagram showing another example of a driving signal generated by the driver of FIG. 2, according to an embodiment.

### DETAILED DESCRIPTION OF THE INVENTION

The present embodiments will now be described more fully with reference to the accompanying drawings in which exemplary embodiments are shown.

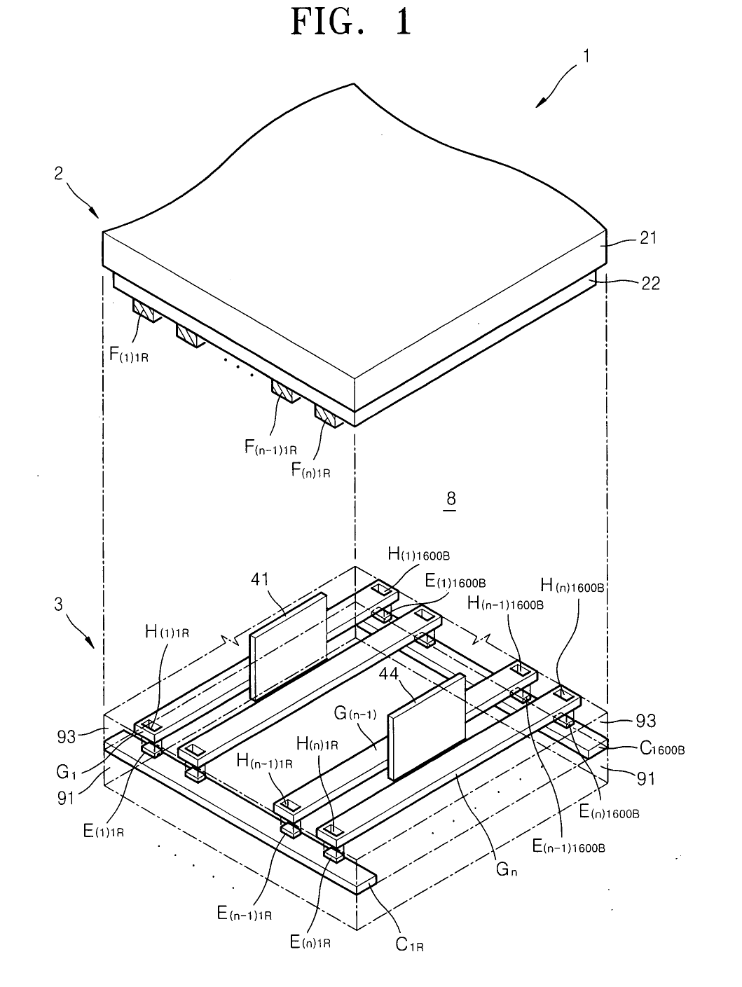

FIG. 1 is an exploded perspective view illustrating a structure of a section of a gas excitation display panel according to an embodiment. Referring to FIG. 1, in the gas excitation display panel 1, an excitation gas 8 is sealed between a front panel 2 and a rear panel 3.

The excitation gas 8 may be an Xe gas or at least one of a gas such as N₂, D₂, CO₂, H₂, CO, Kr, or air mixed with Xe gas.

The front panel 2 and the rear panel 3 are supported by barrier ribs 41 and 44. Besides the barrier ribs 41 and 44 in FIG. 1, a plurality of barrier ribs are formed between cathode electrode lines C_{1R}, . . . , C_{1600B} which are data electrode lines. Accordingly, mutual interference between adjacent discharge cells can be prevented.

The rear panel 3 includes a rear substrate 91, the cathode electrode lines C_{1R}, . . . , C_{1600B} as data electrode lines, electron emitters E_{(1)1R}, . . . , E_{(n)1600B}, an insulating layer 93, and gate electrode lines G₁, . . . , Gₙ as scan electrode lines.

The cathode electrode lines C_{1R}, . . . , C_{1600B} to which data signals are applied are electrically connected to the electron emitters E_{(1)1R}, . . . , E_{(n)1600B}. Through holes H_{(1)1R}, . . . , H_{(n)1600B} corresponding to the electron emitters E_{(1)1R}, . . . , E_{(n)1600B} are formed in the insulating layer 93 and the gate electrode lines G₁, . . . , Gₙ. That is, the through holes H_{(1)1R}, . . . , H_{(n)1600B} are formed in the gate electrode lines G₁, . . . , Gₙ to which scan signals are applied where the gate electrode lines G₁, . . . , Gₙ cross the cathode electrode lines C_{1R}, . . . , C_{1600B}.

The electron emitters E_{(1)1R}, . . . , E_{(n)1600B} can be formed of, for example, oxidized porous poly-silicon (OPS) or carbon nanotubes (CNT).

The front panel 2 includes a front transparent substrate 21, an anode plate 22, and phosphor cells F_{(1)1R}, . . . , F_{(n)1R}. The phosphor cells F_{(1)1R}, . . . , F_{(n)1R} are formed corresponding to the through holes H_{(1)1R}, . . . , H_{(n)1600B} which are formed in the gate electrode lines G₁, . . . , Gₙ. A positive polarity electric potential is applied to the anode plate 22 so that electrons emitted from the electron emitters E_{(1)1R}, . . . , E_{(n)1600B} move towards the phosphor cells F_{(1)1R}, . . . , F_{(n)1R}.

An operation of the gas excitation display panel 1 will now be described.

Electrons are emitted from the electron emitters E_{(1)1R}, . . . , E_{(n)1600B}. A gas 8 is excited by the emitted electrons. Ultraviolet rays are generated while the excited gas 8 stabilizes. The ultraviolet rays excite the phosphor cells F_{(1)1R}, . . . , F_{(n)1R}, thus visible light is emitted.

That is, without generating plasma or a gas discharge, the gas 8 can be excited using the emitted electrons. Accordingly, a discharge display apparatus can display an image with a low driving power.

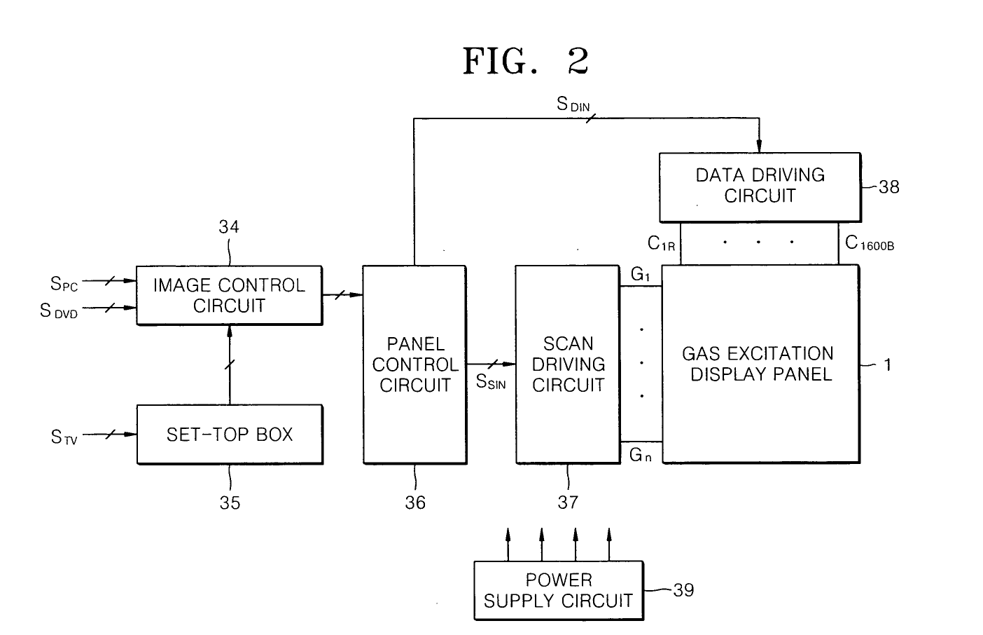

FIG. 2 is a block diagram showing the configuration of a driver of the gas excitation display panel of FIG. 1, according to an embodiment. Referring to FIG. 2, a driver of the gas excitation display panel 1 of FIG. 1 includes an image control circuit 34, a set-top box 35, a panel control circuit 36, a scan driving circuit 37, a data driving circuit 38, and a power supply circuit 39.

The image control circuit 34 processes an image signal S_{PC} received from a computer, an image signal S_{DVD} received from a digital versatile disk (DVD), and an image signal received from the set-top box, and inputs the image signals to the panel control circuit 36. The set-top box 35 processes an image signal S_{TV} of a television and inputs the image signal S_{TV} to the image control circuit 34.

The panel control circuit 36 generates scan-drive control signals S_{SIN} and data-drive control signals S_{DIN} by processing the image signals received from the image control circuit 34. The scan driving circuit 37 drives the gate electrode lines G₁, . . . , Gₙ of the gas excitation display panel 1 in response to the scan-drive control signals S_{SIN} received from the panel control circuit 36.

The data driving circuit 38 drives the cathode electrode lines C_{1R}, . . . , C_{1600B} of the gas excitation display panel 1 in response to the data-drive control signals S_{DIN} received from the panel control circuit 36.

While a scan pulse is sequentially applied to the gate electrode lines G₁, . . . , Gₙ which act as scan electrode lines, a negative polarity data pulse is applied to the cathode electrode lines C_{1R}, . . . , C_{1600B} which act as data electrode lines. Here, a grey scale display can be performed according to the electric potential of the negative polarity data pulse or applying time.

The power supply circuit 39 supplies necessary electric potential to the image control circuit 34, the set-top box 35, the panel control circuit 36, the scan driving circuit 37, the data driving circuit 38, and the anode plate 22 of the gas excitation display panel 1.

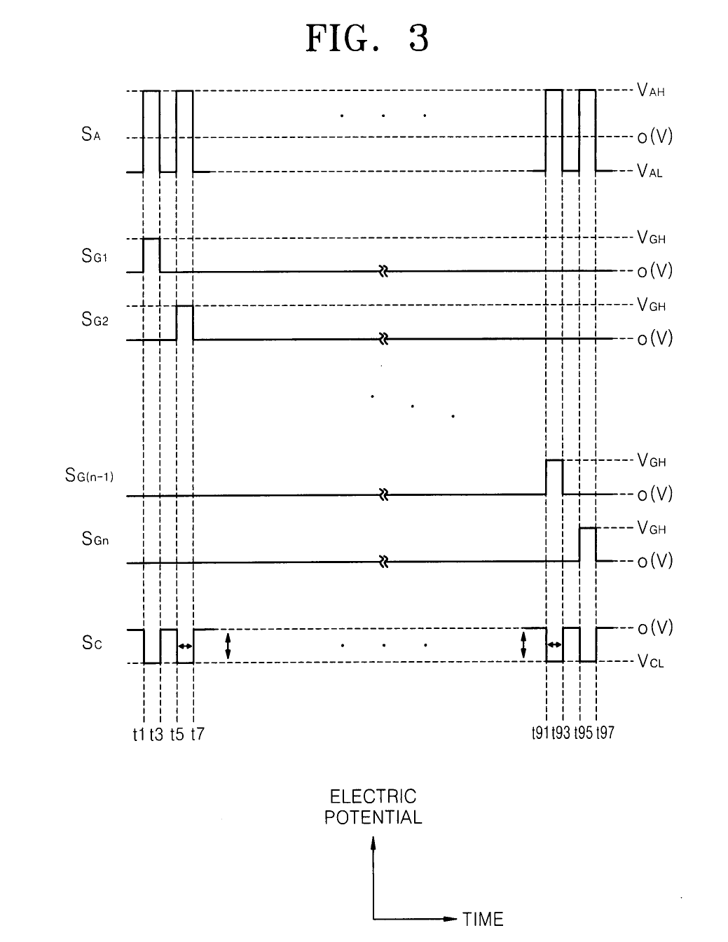

FIG. 3 is a timing diagram showing an example of a driving signal generated by the driver of FIG. 2, according to an embodiment. In FIG. 3, SA indicates a driving signal of the anode plate 22, S_{G1} indicates a driving signal applied to the first gate electrode line G₁, S_{G2} indicates a driving signal applied to the second gate electrode line G₂, S_{Gn} indicates a driving signal applied to the nth gate electrode line Gₙ, and S_{C} indicates a driving signal applied to the cathode electrode lines C_{1R}, . . . , C_{1600B}.

An example of a driving signal generated by the driver of FIG. 2 will now be described with reference to FIGS. 1 through 3.

In a vertical display period t1 to t97, a positive polarity scan pulse having a set positive polarity electric potential V_{GH} and a set pulse width corresponding to the interval of t1 to t3 is sequentially applied to the gate electrode lines G₁, . . . , Gₙ, and negative polarity data pulses corresponding to the positive polarity scan pulse are applied to the cathode electrode lines C_{1R}, . . . , C_{1600B}.

The electric potential V_{CL} and/or applying time of the negative polarity data pulses applied to the cathode electrode lines C_{1R}, . . . , C_{1600B} vary according to grey scales. For example, a width of a negative polarity data pulse having a maximum grey scale is identical to the width of the positive polarity scan pulse. Also, if the negative polarity data pulse has a minimum grey scale, the width of the negative polarity data pulse is 0, thus, an electric potential of 0 V is applied.

Each of the horizontal driving periods (for example, t1 to t5) includes a horizontal display time (for example, t1 to t3) and a blanking time (for example, t3 to t5).

In each of the horizontal display times (for example, t1 to t3), the polarity of the electric potential V_{AH} of the anode plate 22 is positive. In each of the blanking times (for example, t3 to t5) the polarity of the electric potential V_{AL} of the anode plate 22 is negative. In this way, since the polarity of the electric potential of the anode plate 22 is alternating, electrons accumulated in the phosphor cells F_{(1)1R}, . . . , F_{(n)1R} in the horizontal display time (for example, t1 to t3) can return to the electron emitters E_{(1)1R}, . . . , E_{(n)1600B} in the blanking time (for example, t3 to t5). As the result of reset effect, performance and efficiency of overall operation are increased.

A positive polarity electric potential V_{GH} is applied to the gate electrode line (for example, G₁) to be scanned in the horizontal display time (for example, t1 to t3). In the blanking time (for example, t3 to t5) following the horizontal display time (for example, t1 to t3), zero electric potential 0V is applied to the gate electrode line (for example, G1).

A negative polarity electric potential V_{CL} is applied to the cathode electrode lines C_{1R}, . . . , C_{1600B} in the horizontal display time (for example, t1 to t3).

Also, zero electric potential 0V is applied to the cathode electrode lines C_{1R}, . . . , C_{1600B} in the blanking time (for example, t3 to t5). As described above, a grey scale is realized by at least one of the electric potential V_{CL} and applying time of the negative polarity data pulse applied to the cathode electrode lines C_{1R}, . . . , C_{1600B}.

As described above, in the horizontal display time (for example, t1 to t3), electrons are emitted from the electron emitters E_{(1)1R}, . . . , E_{(n)1600B}. Next, the gas 8 is excited by the emitted electrons. While the excited gas 8 is stabilized, ultraviolet rays are generated, and the ultraviolet rays excite the phosphor cells F_{(1)1R}, . . . , F_{(n)1R}. Thus, the phosphor cells F_{(1)1R}, . . . , F_{(n)1R} emit visible light.

That is, without generating gas discharge, the gas 8 can be excited by the emitted electrons. Accordingly, a discharge display apparatus can display an image with a low driving power.

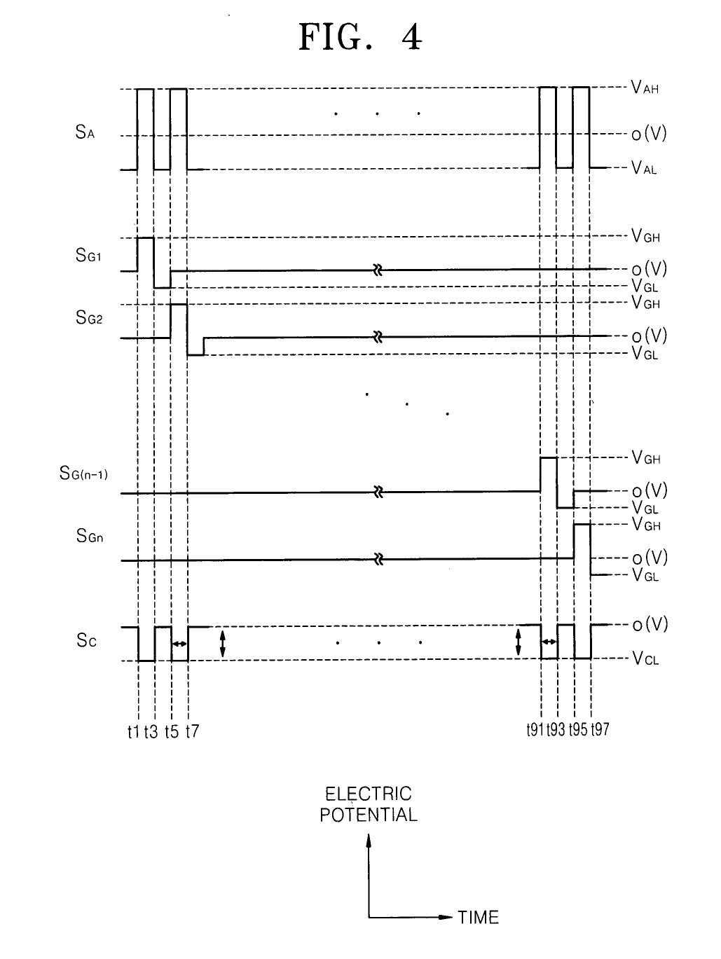

FIG. 4 is a timing diagram showing another example of a driving signal generated by the driver of FIG. 2, according to an embodiment. In FIGS. 3 and 4, like reference numerals denote like elements having the same function, thus the detailed descriptions thereof will not be repeated. However, the only difference in the timing diagram of FIG. 4 from the timing diagram of FIG. 3 is that a negative polarity electric potential V_{GL} is applied to the scanned gate electrode line (for example, G₁) in the blanking time (for example, t3 to t5) which is after the horizontal display time (for example, t1 to t3). Accordingly, in the blanking time (for example, t3 to t5), the amount of electrons returning to the electron emitters E_{(1)1R}, . . . , E_{(n)1600B} from the phosphor cells F_{(1)1R}, . . . , F_{(n)1R} can be increased.

In the present embodiment described above, the scan electrode lines and the data electrode lines respectively correspond to the gate electrode lines G₁, . . . , Gₙ and the cathode electrode lines C_{1R}, . . . , C_{1600B}. In reverse, the scan electrode lines and the data electrode lines can also respectively correspond to the cathode electrode lines C_{1R}, . . . , C_{1600B} and the gate electrode lines G₁, . . . , Gₙ.

As described above, in a gas excitation display apparatus according to the present embodiments, electrons are emitted from electron emitters during a horizontal display time, a gas is excited by the emitted electrons, ultraviolet rays are generated while the excited gas stabilizes, phosphor cells are excited by the ultraviolet rays, and then the phosphor cells emit visible light.

That is, without generating gas discharge, the gas can be excited by the emitted electrons. Accordingly, a discharge display apparatus can display an image with a low driving power.

Also, the electric potential of an anode plate is alternately changed. Therefore, electrons accumulated in the phosphor cells in the horizontal display time can return to the electron emitters in the blanking time. As a result of the reset operation effect, overall performance and efficiency of a gas excitation display apparatus can be increased.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A gas excitation display apparatus having a gas excitation display panel and a driver for driving the gas excitation display panel,
wherein the gas excitation display panel comprises:
electron emitters, data electrode lines, scan electrode lines crossing the data electrode lines, phosphor cells, an excitation gas filled in a space between the phosphor cells and the electron emitters, and an anode plate to which an electric potential is applied such that electrons emitted from the electron emitters move towards the phosphor cells, wherein
each horizontal driving period comprises a horizontal display time and a blanking time, and
an electric potential applied to the anode plate in the horizontal display time is positive and an electric potential applied to the anode plate in the blanking time is negative.

2. The gas excitation display apparatus of claim 1, wherein the data electrode lines are cathode electrode lines which are electrically connected to the electron emitters.

3. The gas excitation display apparatus of claim 2, wherein the scan electrode lines act as gate electrode lines in which through holes corresponding to the electron emitters are formed on regions where the gate electrode lines cross the cathode electrode lines.

4. The gas excitation display apparatus of claim 3, wherein
an electric potential of positive polarity is applied to the gate electrode lines to be scanned in the horizontal display time, and
an electric potential of negative polarity is applied to the gate electrode lines in the blanking time which is after the horizontal display time.

5. The gas excitation display apparatus of claim 3, wherein barrier ribs are formed between the cathode electrode lines.

6. The gas excitation display apparatus of claim 3, wherein
an electric potential of negative polarity is applied to the cathode electrode lines in the horizontal display time, and
an electric potential of zero is applied to the cathode electrode lines in the blanking time.

7. The gas excitation display apparatus of claim 6, wherein, during the horizontal display time, a grey scale is realized by at least one of the electric potential of negative polarity applied to the cathode electrode lines and the applying time of the negative polarity electric potential to the cathode electrode lines.

8. The gas excitation display apparatus of claim 1, wherein, during the horizontal display time, electrons are emitted from the electron emitters due to the electric potential of negative polarity being applied to the cathode electrode lines.

9. The gas excitation display apparatus of claim 8, wherein, during the horizontal display time, the gas is excited by the electrons emitted from the electron emitters.

10. The gas excitation display apparatus of claim 9, wherein, during the horizontal display time, ultraviolet rays are generated while the excited gas stabilizes.

11. The gas excitation display apparatus of claim 10, wherein, during the horizontal display time, the generated ultraviolet rays excite the phosphor cells and the phosphor cells emit visible light.

12. The gas excitation display apparatus of claim 1, wherein the excitation gas comprises Xe.

13. The gas excitation display apparatus of claim 12, wherein the excitation gas further comprises at least one selected from the group consisting of N₂, D₂, CO₂, H₂, CO, and Kr.

14. The gas excitation display apparatus of claim 1, wherein the electron emitters are formed of oxidized porous poly-silicon (OPS).

15. The gas excitation display apparatus of claim 1, wherein the electron emitters are formed of carbon nanotubes (CNTs).
